(19) United States
(12) Patent Application Publication
(10) Pub. No.: US 2024/0259914 A1
(43) Pub. Date: Aug. 1, 2024

(54) METHOD FOR IMPROVEMENTS IN AND RELATING TO PROXIMITY SERVICES

(71) Applicant: Samsung Electronics Co., Ltd., Suwon-si, Gyeonggi-do (KR)

(72) Inventors: Mehrdad SHARIAT, Staines (GB); Mahmoud WATFA, Staines (GB)

(21) Appl. No.: 18/561,125

(22) PCT Filed: May 17, 2022
(86) PCT No.: PCT/KR2022/007022

§ 371 Date: Nov. 15, 2023

(30) Foreign Application Priority Data
May 17, 2021 (GB) 2107030.5
Oct. 8, 2021 (GB) 2114446.4
May 9, 2022 (GB) 2206718.5

(51) Int. Cl. H04W 48/04; H04W 48/16

(52) U.S. Cl. CPC H04W 48/04; H04W 48/16

(57) ABSTRACT

The disclosure relates to a 5G or 6G communication system for supporting a higher data transmission rate. This disclosure discloses a method of controlling a 5G network performed by a network entity in a wireless communication, the method comprising defining a Proximity Services, ProSe, behaviour of at least one of first UE or the second UE in respect of a restricted service area.

### CROSS-REFERENCE TO RELATED APPLICATION(S)

This application is a U.S. National Stage application under 35 U.S.C. § 371 of an International application number PCT/KR2022/007022, filed on May 17, 2022, which is based on and claims priority of a United Kingdom patent application number 2107030.5, filed on May 17, 2021, in the United Kingdom Intellectual Property Office, and of a United Kingdom patent application number 2114446.4, filed on Oct. 8, 2021, in the United Kingdom Intellectual Property Office, and of a United Kingdom patent application number 2206718.5, filed on May 9, 2022, in the United Kingdom Intellectual Property Office, the disclosure of each of which is incorporated by reference herein in its entirety.

### TECHNICAL FIELD

The present invention relates to Proximity Services (ProSe), particularly ProSe support for user equipment (UEs) in Restricted Service Areas.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (MLE), Al service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and Al (Artificial Intelligence) from the design stage and internalizing end-to-end Al support functions, and next-generation distributed computing technology for implementing services at levels of complexity exceeding the limit of UE operation capability by utilizing ultra-high-performance communication and computing resources.

### Overview of 5G Proximity Services (ProSe)

Proximity services (ProSe) for the 5GS is being specified in TS 23.752 [1]. ProSe allows for direct discovery and communication between UEs using so called “PC5 resources” where these resources don't require other resources in the core network. ProSe also enables UEs either in coverage or out of coverage, known as Remote UEs to get service via a relay UE which is known as a UE-to-network Relay (hereafter referred to as relay UE), where the relay UE is in coverage of the network. The remote UEs will use PC5 discovery and communication to discover, establish a connection, and exchange data via the relay UE towards the network.

### Overview of Service Area Restrictions

TS 23.501 [2] and TS 24.501 [3] describe the concept of service area restriction which is one type of mobility restrictions that are defined in [2]. The service area restriction is a set of TAIs in which the UE cannot get normal services except for some conditions or cases that are defined in [2] and [3].

Note: the service area restriction may be defined such that the Tracking Area Identity (TAI)s indicate where the UE can get normal service and hence all other TAIs would be considered as TAIs in which the service is restricted.

Some of the exceptions on service area restriction are as follows: while the UE is not allowed to initiate a service request procedure, an exception to this would be the case when the UE is initiating the procedure due to:
emergency services,
any reason given the UE is a high priority access UE
response to paging

Note that the definition of a high priority access is as follows from [3]:

“UE configured for high priority access in selected PLMN: A UE configured with one or more access identities equal to 1, 2, or 11-15 applicable in the selected PLMN as specified in subclause 4.5.2. Definition derived from 3GPP TS 22.261 [3].”

The configuration for high priority access as defined above happens in the USIM running on top of UICC.

### DISCLOSURE

### Technical Solution

The Expected Behavior of a ProSe Capable UE is not Defined when the UE is in a Restricted Service Area

This sub-section does not address relay UE in restricted service areas. The related problem is described in the next sub-section.

It is not clear if the UE which is ProSe capable would be allowed to perform e.g. ProSe direct discovery (or PC5 discovery) when the UE is in a restricted service area. An expected behaviour for the UE needs to be specified so that a given ProSe-based service would work as expected, optionally for certain applications or uses cases. For example, perhaps not all ProSe capable UEs should use ProSe service in a restricted service area but it may be the case that UEs that belong to a certain group may be allowed to do so. This is because the group may be one that is known to engage in public safety type of services, etc.

Also, direct discovery may be performed across PLMNs i.e. a UE, say UE 1, from PLMN X may send PC5 discovery messages (e.g. announce requests) to announce its presence such that another UE, say UE 2, from PLMN Y may discover UE 1. When UE 2 determines that a match has occurred with the related ProSe discovery codes, UE 2 may need to send a match report to the 5G Direct Discovery Name Management Function (DDNMF) as described in [1]. However, due to UE 2 being a restricted area, this cannot be done as there is current restriction on the service request procedure. However, the match may be valid for a certain time during which the UE 2 may move into a non-restricted area in which a service request procedure would then be allowed. How the UE 2 will behave with respect to sending a match report for a code that was detected while in a restricted area is not specified.

The Current Behavior for Relay UEs while in a Restricted Area is not Optimal

The following is specified in [1] about relay UEs and remote UEs with respect to restricted service areas:

### “Service Area Restriction: Allowed Area, Non-Allowed Area

Allowed Area applies as is for a UE-to-Network Relay and Remote UE.

A UE-to-Network Relay (resp. Remote UE) is allowed to initiate communication with the network (resp. with the network via a UE-to-Network Relay) as allowed by subscription.
A UE-to-Network Relay may only perform UE-to-Network Relay operation in an Allowed Area.
Non-allowed Area applies as is for a UE-to-Network Relay and Remote UE. The UE (UE-to-Network Relay or Remote UE) and the network are not allowed to initiate Service Request or SM signalling to obtain user services (both in CM-IDLE and in CM-CONNECTED states). RM procedures for non-3GPP access aspects are not applicable for the Remote UE.
When the UE-to-Network Relay UE enters a non-allowed Area and the UE-to-Network Relay cannot provide relay service, it may release the PC5 unicast connection with a cause code informing the remote UE of UE-to-Network Relay in Non-allowed area.

NOTE 1: The above bullet on Service Area Restriction changing due to UE-to-Network Relay's mobility will be evaluated separately from other parts of solution #7.”

Assume the UE, say UE A, is in coverage of the RAN and furthermore assume that UE A is in a restricted service area. Here, there is a possibility that UE A is actually a high priority access UE which is therefore exempt from the service area restrictions.

Similarly, a relay UE, say UE R, that is in a restricted service area may also be a high access priority UE and so this UE, as per the current specifications, will be exempt from the service area restrictions and as such can initiate any procedure.

The following problems can be identified:
i. The current requirement stating “A UE-to-Network Relay may only perform UE-to-Network Relay operation in an Allowed Area” should not apply to a relay UE that is configured as a high priority access UE
ii. If a relay UE, say one that is high priority access UE, is allowed to serve a remote UE while the relay is in a restricted area, the determination as to whether a particular remote UE can be served needs to also consider if the remote UE (if also located in a restricted service area of its own serving PLMN) is also a high priority access or not. This is because, had the remote UE e.g. UE A, be directly served by the RAN, then UE A would have been exempt from the service area restrictions. Now that UE A is remote and can use the relay UE, say UE R, then determining to allow service for UE A, via the relay UE R which is in a restricted area, should require specific conditions to be met for both UE A (the remote UE) and UE R (the relay UE), or for the UE R (the relay UE) only if the service restrictions are not applicable to the remote UE. In other words, making exemptions for any communication by a relay UE is not accurate as the exemption needs to also consider any possible exemptions on the remote UE that want to use the relay UE. The final exemption (as to allow communication in a restricted area) should consider both the remote UE (if/when applicable) and the relay UE. If both UEs are deemed to be exempt from service area restrictions (or when service area restrictions are not applicable), only then the communication should be permitted for the remote UE via the relay UE that is in a restricted area.

According to the present invention there is provided an apparatus and method as set forth in the appended claims. Other features of the invention will be apparent from the dependent claims, and the description which follows.

According to a first aspect of the present invention, there is provided a method of controlling a 5G network comprising a set of user equipment, UEs, including a first UE and a second UE, the method comprising:
defining a Proximity Services, ProSe, behaviour of the first UE and/or the second UE in respect of a restricted service area.

In an embodiment, defining the ProSe behaviour of the first UE or the second UE in respect of the restricted service area comprises:
denying a or all PC5 ProSe procedure(s) in the restricted service area;
permitting a or all PC5 ProSe procedure(s) in the restricted service area;
conditionally permitting a or all PC5 ProSe procedure(s) in the restricted service area; or permitting a or all PC ProSe procedure(s) applicable to the first UE and/or the second UE as being in limited service state even though the first UE and/or the second UE is in state 5GMM-REGISTERED.NON-ALLOWED-SERVICE.

In an embodiment, defining the ProSe behaviour of the first UE or the second UE in respect of the restricted service area comprises the first or the second UE applying the behaviour of a UE in a limited service state even though the first UE and/or the second UE is in state 5GMM-REGISTERED.NON-ALLOWED-SERVICE.

In an embodiment, the second UE determines TAI of a serving cell associated with the first UE, based on PC5 discovery and/or signaling messages

In an embodiment, the second UE determines TAI of a serving cell which was received in any PC5 discovery and/or signaling messages to be the TAI on which the first UE is camping on.

In an embodiment, the second UE compares a TAI of the first UE serving cell against the at least one TAI of its last or current registration area and wherein if the TAI of the first UE matches any of the at least one TAIs in the second UE's last or current registration area, or last or current service area information, then the second UE may further verify if the TAI is considered to be an allowed TAI or a non-allowed TAI.

In an embodiment, defining the ProSe behaviour of the first UE in respect of the restricted service area comprises permitting the first UE to perform a service request procedure to transition to a connected mode for the purpose of PC5 discovery and/or PC5 communication, when the first UE is positioned in the restricted service area.

In an embodiment, defining the ProSe behaviour of the first UE in respect of the restricted service area comprises permitting the first UE to perform a registration procedure in order to transition to a connected mode for the purpose of PC5 discovery and/or PC5 communication, when the first UE is positioned in the restricted service area.

In an embodiment, defining the ProSe behaviour of the first UE in respect of the restricted service area comprises permitting the first UE to perform PC5 discovery and/or PC5 communication, for example if the UE is in a 5GMM-CONNECTED mode or in a 5GMM-CONNECTED mode with RRC inactive indication, when the first UE is positioned in the restricted service area.

10. The method according to claim 9, wherein permitting the first UE to perform PC5 discovery comprises conditionally permitting the first UE to perform PC5 discovery, for example wherein a condition requires that if the first UE detects a match, the first UE must wait until entering or exiting the restricted area before sending a match report.

In an embodiment, defining the ProSe behaviour of the first UE in respect of the restricted service area comprises permitting the first UE to contact the network for a match report or to request a ProSe code for PC5 discovery and/or to perform PC5 communications, when the first UE is positioned in the restricted service area.

In an embodiment: preconfiguring the first UE and/or the second UE according to the defined ProSe behaviour; communicating, by the network, the defined ProSe behaviour to the first UE and/or the second UE; and/or configuring the first UE and/or the second UE according to the defined ProSe behaviour, for example in the USIM or provisioned in the ME.

In an embodiment, defining the ProSe behaviour of the first UE in respect of the restricted service area comprises mandating that the first UE must not support or may selectively support the second UE for ProSe services, when the first UE is positioned in the restricted service area.

In an embodiment, the first UE and/or the second UE are exempted from ProSe behaviour in the restricted service area when they are configured for Multimedia Priority Service (MPS), Mission Critical Services (MCS) or another high priority access service.

In an embodiment, the another high priority access service is explicitly or implicitly identified by Relay Service Codes as preconfigured or provisioned to the first UE and/or the second UE or based on other indications in the discovery messages or responses

In an embodiment, allowing, the first UE and/or the second UE, an exempted ProSe service, when the first UE and/or the second UE is positioned in the restricted service area.

In an embodiment, allowing, the first UE and/or the second UE, the ProSe service, when the first UE and/or the second UE is positioned in the restricted service area, comprises using, by the first UE, the ProSe service as a relay and/or using, by the second UE, the ProSe service as a Remote UE.

According to a second aspect of the present invention, there is provided a 5G network comprising a set of user equipment, UEs, including a first UE and a second UE, wherein the network is configured to:

define a Proximity Services, ProSe, behaviour of the first UE and/or the second UE in respect of a restricted service area.

Note that the proposals herein may be provided using the term UE-to-Network Relay UE, however this may refer to a Layer-2 UE-to-Network Relay UE, a Layer-3 UE-to-Network Relay UE, or both. As such, the proposals should be considered as an example but not a limitation. The proposals herein can be applied in any order and in any combination.

### DESCRIPTION OF DRAWINGS

For a better understanding of the invention, and to show how embodiments of the same may be carried into effect, reference will now be made, by way of example, to the accompanying diagrammatic drawings in which:

FIG. 1 shows a message flow according to an embodiment of the present invention;

FIG. 2 shows a flowchart relating to the case showing general behaviour between UE with high access priority vs UE without high access priority;

FIG. 3 shows a flowchart related to the case when the UE is in a non-allowed area and moves into an allowed area, showing the switch in behaviour accordingly; and

FIG. 4 shows a flowchart related to the case when the UE is an allowed area & moves to a non-allowed area, showing the switch in behaviour accordingly.

FIG. 5 shows various hardware components of the network entity (500) in the wireless communication system, according to an example embodiment as disclosed herein.

FIG. 6 shows various hardware components of the UE (600) in the wireless communication system, according to an example embodiment as disclosed herein.

### MODE FOR INVENTION

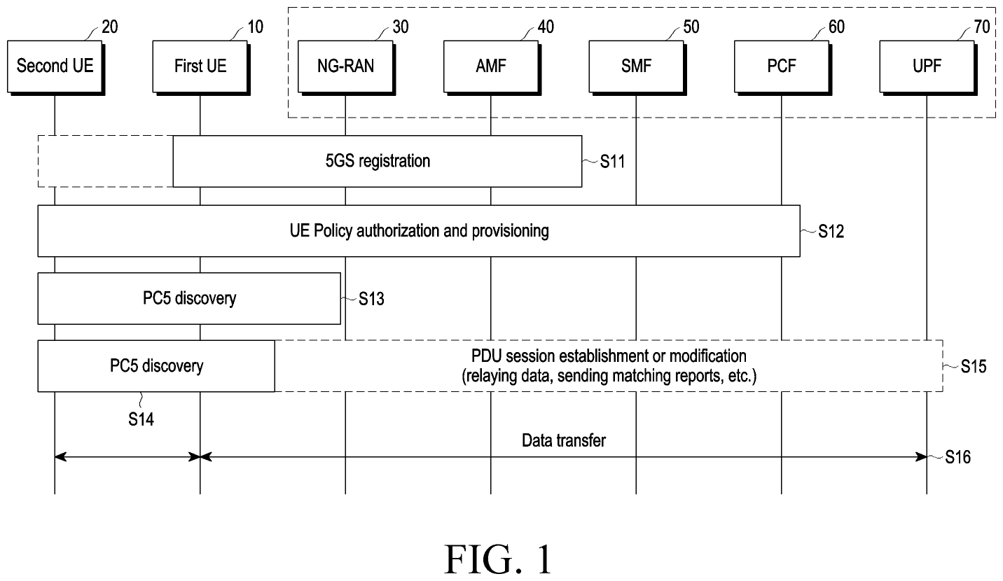

FIG. 1 shows a general overview of message flows in accordance with an embodiment of the invention. It shows messages exchanged between entities: First UE 10, Second UE 20, NG-RAN 30, AMF 40, SMF 50, PCF 60 and UPF 70. In more detail, the steps S11 to S16 are described below.

S11. The UE (either First UE or Second UE) performs registration, e.g. with network. Different options as outlined herein can be followed when the UE is in a restricted service area. For example, the UE may be allowed to perform a service request procedure (by sending a Service Request or Control Plane Service Request message) to transition to a connected mode for the purpose of PC5 discovery and/or PC5 communication. For example, in another option, the UE should not send the Uplink data status IE in the (Control Plane) Service Request message so as to not request user plane resources. For example, in another option, the UE can only request the establishment of user plane resources if the user plane resources are to be used for contacting the 5G DDNMF. For example, the UE may be allowed to perform a service request procedure (by sending a Service Request or Control Plane Service Request message) only if a ProSe Service is exempted from service area restrictions.

S12. During Service authorization and provisioning, the First UE or Second UE (when applicable), may be informed by the network about the allowed default behaviour (in terms of ProSe direct discovery/direct communication when in a restricted service area), where the indication may be sent in any NAS message or NAS container or a new IE in a NAS message/container e.g. Registration Accept, Configuration Update Command. The UE Configuration Update procedure for access and mobility management related parameters can be triggered by/via the AMF. This can also be based on e.g. AM policy Association Establishment/Modification initiated according to policy decisions from PCF or other peers of PCF, i.e. UDR, AF or NWDAF, etc. The UE may receive a new indication from the network, e.g. in a new IE of any new/existing NAS message, or as part of a new/existing container, etc. indicating the allowed default behaviour for the UE (in terms of ProSe direct discovery/direct communication when in a restricted service area). Relay Service codes implying a service of high priority (e.g. MPS, MCS, etc.) can be provisioned as part of this step via PCF based on the policy decisions from PCF or other peers of PCF, i.e. UDR, AF or NWDAF. This information can also be received from any network node e.g. AMF, using any NAS message, or from the application layer, or from the 5G DDNMF. This info can be configured in USIM (on top of UICC) or provisioned in ME.

As part of S12, the UE can be pre-configured with certain URSP rules indicating whether to choose options outlined for direct network operation or options outlined for indirect network operation. Alternatively a the UE can be provisioned with such URSP rules from the PCF in the HPLMN as outlined under URSP/ANDSP of ProSe UEs when in a Restricted Service Area.

S13. The UE (either First UE or Second UE) follows PC5 discovery in a restricted service area based on the info provisioned in S12. For example, the UE is allowed to perform fully PC5 discovery in a restricted area; and/or optionally the UE is allowed to perform PC5 discovery when in idle mode (similar to the case of the UE being in limited state); or for example, UE is allowed to perform PC5 discovery, however, if the UE detects a match, the UE should wait until it enters (or it leaves) the restricted area before sending a match report to the 5G DDNMF; or the UE is allowed to perform PC5 discovery in a restricted area for certain high priority services e.g. based on Relay Service Codes or based on other indications in the discovery messages or responses.

S14. The UE (either First UE or Second UE) follows PC5 discovery in a restricted service area based on the info provisioned in S12 and S13. For example, when the UE is allowed to perform PC5 communication in a restricted area, it may establish a PDU session with the network; and/or optionally if the UE is allowed to perform PC5 communication when in idle mode (similar to the case of the UE being in limited state), it should not send the Uplink data status IE in the (Control Plane) Service Request message so as to not request user plane resources; or for example, if UE is allowed to perform PC5 communication, when the UE detects a match, the UE may (or should) wait until it enters (or it leaves) the restricted area before sending a match report to the 5G DDNMF; or if the UE is allowed to perform PC5 communication in a restricted area for certain Relay Service Codes or based on other indications, it may follows PC5 communication as normal exempted from restrictions.

The UE follows URSP rules as provisioned in S12 to establish a PDU session with the network (when applicable, e.g. in case of relaying data).

S15. Data transfer is carried out over the established session (e.g. in case of relaying data).

The Expected Behavior of ProSe UEs when in a Restricted Service Area

In this clause and subsequent clauses, the terms relay, UE relay, ProSe UE-to-Network Relay are used interchangeably (i.e. these terms are synonymous).

In this clause and subsequent clauses, the terms UE and ProSe capable UE are used interchangeably (i.e. these terms are synonymous).

This clause defines different possible options of UE Behaviour for using ProSe when the UE is in a restricted service area.

The restricted service area in this invention is always considered with respect to the (relay or remote) UE's own serving PLMN unless otherwise stated.

Since PC5 procedures do not use any Uu resources or resources from the core network, the existing service area restrictions may not always fit the nature of PC5 procedures that are transparent to the core network.

Possible solutions include:
In one variant of the invention, a default behaviour for any ProSe capable UE (i.e. either for direct discovery/direct communication between peer UEs or for relaying between remote UE and relay UE, or for any ProSe enabled UE or between any ProSe capable UEs) is defined, where this default behaviour may be as follows:
   No PC5 ProSe procedure (either operator-managed or non-operator managed) is allowed while in a restricted service area;
   All PC5 ProSe procedures are allowed while in a restricted service area;
   Principles of limited service state are applicable, i.e. a ProSe capable UE shall only use the operator-managed radio resources and procedure available in CM-IDLE mode for ProSe over PC5 reference point. However, a ProSe capable UE may still use ProSe over PC5 reference point using the “non-operator-managed” radio resources.
   Here, peer ProSe capable UEs can be defined as a pair of UEs or a particular group of UEs to use PC5 ProSe procedure based on any of the behaviours defined above.
In another variant of the invention, the default behaviour may also be any of the following:
   When in a restricted area, the ProSe capable UE may be allowed to perform a service request procedure (by sending a Service Request or Control Plane Service Request message) to transition to connected mode for the purpose of PC5 discovery and/or PC5 communication, optionally:

The UE should not send the Uplink data status IE in the (Control Plane) Service Request message so as to not request user plane resources
When in a restricted area, the ProSe capable UE may be allowed to perform a registration procedure (by sending a Registration Request message) to transition to connected mode for the purpose of PC5 discovery and/or PC5 communication, optionally:

The UE should not send the Uplink data status IE in the (Control Plane) Service Request message so as to not request user plane resources
When in a restricted area, the ProSe capable UE can perform PC5 discovery and/or PC5 communication if the UE is in 5GMM-CONNECTED mode, or in 5GMM-CONNECTED mode with RRC inactive indication
When in a restricted area and optionally:

If the ProSe capable UE is in 5GMM-CONNECTED mode (or in 5GMM-CONNECTED mode with RRC inactive indication), the UE can only request the establishment of user plane resources if the user plane resources are to be used (or are associated with a PDU session that is used) for contacting the 5G DDNMF. For example, the UE may be aware of which PDU session is used for this purpose e.g. based on a DNN and/or slice parameter that is/are associated with the PDU session. As such, the UE can request the establishment of user plane resources by setting the necessary bit that corresponds to the PDU session identity which is used for contacting the 5G DDNMF. The ProSe capable UE may not do so if it is in 5GMM-IDLE mode. In this case, the UE can include UL data status IE (in the NAS message e.g. Service Request or Registration Request) to request the establishment of user plane resources, and the IE shall only request resources for the PDU session that is used to connect to the 5G DDNMF

Alternatively, if the ProSe capable UE is in 5GMM-IDLE mode (or in 5GMM-IDLE mode with suspend indication), the UE can only request the establishment of user plane resources (or can request the lower layers to resume the RRC connection) if the user plane resources are to be used (or are associated with a PDU session that is used) for contacting the 5G DDNMF (e.g. where the PDU session for this purpose can be identified as described above). In this case, the UE can include UL data status IE (in the NAS message e.g. Service Request or Registration Request) to request the establishment of user plane resources, and the IE shall only request resources for the PDU session that is used to connect to the 5G DDNMF (e.g. where the PDU session for this purpose can be identified as described above)
Alternatively, the ProSe capable UE can take any of the actions above if the UE needs to contact the 5G DDNMF for a match report, or to request a ProSe code for PC5 discovery and/or to perform PC5 communications (e.g. where the PDU session for this purpose can be identified as described above).

Note that the ProSe capable UE may be preconfigured to behave (in terms of ProSe direct discovery/direct communication when in a restricted service area) in a default manner, where the default manner may be any combination of the proposals above.

Alternatively, the ProSe capable UE may be informed by the network about the allowed default behaviour (in terms of ProSe direct discovery/direct communication when in a restricted service area), where the indication may be sent in any NAS message or NAS container or a new IE in a NAS message/container e.g. Registration Accept, Configuration Update Command. The UE Configuration Update procedure for access and mobility management related parameters can be triggered by/via the AMF. This can also be based on e.g. AM policy Association Establishment/Modification initiated according to policy decisions from PCF or other peers of PCF, i.e. UDR, AF or NWDAF, etc. The UE may receive a new indication from the network, e.g. in a new IE of any new/existing NAS message, or as part of a new/existing container, etc. indicating the allowed default behaviour for the UE (in terms of ProSe direct discovery/direct communication when in a restricted service area). The UE may acknowledge receipt of this indication using any existing/new NAS message, existing/new IE, existing/new container, etc. The UE may then locally save the default behaviour (or indication) as received from the network and start operation based on this received indication. The network may use the same methods discussed herein to update this behaviour at the UE by sending a new indication, and similarly the UE should consider the new indication as valid while the previous indication as invalid (and may delete it) such that the UE starts behaving (in terms of ProSe direct discovery/direct communication when in a restricted service area) based on the new indication.

Alternatively, the UE ProSe capable may be configured in the USIM (on top of UICC) or provisioned in ME with a new/existing elementary file which indicates:
Whether or not the UE is allowed to perform PC5 discovery in a restricted area, and/or optionally where the UE may be allowed to perform PC5 discovery when in idle mode (similar to the case of the UE being in limited state)
Whether or not the UE is allowed to perform PC5 communication in a restricted area, and/or optionally where the UE may be allowed to perform PC5 communication when in idle mode (similar to the case of the UE being in limited state)
Whether or not the UE is allowed to perform PC5 discovery and/or PC5 communication as a UE-to-network relay, or as a UE-to-UE relay (regardless of the layer used for the purpose of relaying)

Alternatively, in another variant of the invention, the following UE behaviour is proposed when the UE is in a restricted (service) area:
The ProSe capable UE may perform PC5 discovery (e.g. PC5 announcement and/or PC5 monitoring procedures), however, if the UE detects a match, the UE may (or should) wait until it enters (or it leaves) the restricted area (e.g. the UE enters an allowed area, or leaves the non-allowed area) before sending a match report to the 5G DDNMF. Optionally, the UE may do so after leaving the restricted area if a timer (e.g. a timer that guards the validity of the match that was detected) is still running and has not expired. For example, the UE may start a timer when a match is detected during the UE's presence in a restricted area. When the UE leaves the restricted area, the UE may send a match report to report the previous match if the timer is still running. Otherwise if the timer has expired, the UE should not send the match report even if the UE is not in the restricted area. Optionally, the UE sends a match report when it leaves the restricted service area to report any match that was detected while the UE was in a restricted service area.
Alternatively, if the ProSe capable UE is in a restricted area and detects a match, the UE may start a timer which guards the time during which the UE should wait to send a match report if the UE enters a non-restricted area. As such, if the UE leaves the restricted area (i.e. enters a non-restricted area) then the UE can send a match report and stop the timer. Otherwise, if the timer expires while the UE is still in the restricted area, then the expiry of the timer can be used as an exception for the UE to perform a service request procedure (or to request the lowers layers to resume the RRC connection, if applicable) and/or to request the establishment of the user plane resources for the purpose of sending the match report to the 5G DDNMF. As such, this timer can be seen to be a timer during which it is hoped that the UE leaves the restricted area (and hence no restriction would apply), but if the timer expires while the UE is still in the restricted area, then an exception can be made for the UE such that it can send a match report to the 5G DDNMF.

Note that for all the proposals herein, the following apply in any combination:
CM-IDLE mode may also refer to 5GMM-IDLE mode;
CM-CONNECTED mode may also refer to 5GMM-CONNECTED mode;
The proposals for 5GMM-IDLE mode may also apply for 5GMM-IDLE mode with suspend indication;
The proposals for 5GMM-CONNECTED mode may also apply for 5GMM-CONNECTED mode with RRC inactive indication.

Note that for all the proposals herein may also be applicable based on other forms of restrictions, e.g. RAT restriction, Forbidden Area, or CN type restriction, congestion control (e.g. S-NSSAI congestion control, DNN congestion control, or congestion control for a combination of S-NSSAI and DNN), etc. As such, any of these restrictions may be referred to as “a restriction”. Although the proposals herein may be provided or described using service area restriction (e.g. restricted service area) as an example, the proposals would still apply for any other form of restrictions such as those listed herein. Moreover, the proposals can be used, in any combination, for at least one type of restriction and optionally can be used simultaneously when more than one restriction applies.

The Exemption Behaviour of ProSe UEs when in a Restricted Service Area

This section proposes new behaviour as follows.

When a ProSe UE-to-Network Relay UE is in a restricted service area, it cannot (or should not) support a remote UE for ProSe services unless the relay is a high access priority UE, or depending on the relay service code that the remote UE and/or relay UE is broadcasting where the relay service code may imply a service of high priority (e.g. MPS, MCS, etc.). This info can be configured in USIM (on top of UICC), provisioned in ME or provided/updated via PCF to policy decisions from PCF or other peers of PCF, i.e. UDR, AF or NWDAF. This information can also be received from any network node e.g. AMF, using any NAS message, or from the application layer, or from the 5G DDNMF.

Note that the above conditions for exemption may also apply to a remote UE, (e.g. when the remote UE is in a restricted service area of its own PLMN), where the conditions for an exemption may apply for a remote UE that discovers (via any form of discovery message, or via any discovery model), or detects or determines, that a relay UE is in a restricted area (e.g. of the remote UE's serving PLMN) yet it is exempt (e.g. via means that are explained herein). When the remote UE determines that the relay UE is exempt from the restrictions of a restricted service area, which may be also interpreted that the remote UE is allowed to initiate any form of PC5 procedure (e.g. for PC5 link establishment or PC5 link modification), then the remote UE may indeed initiate any PC5 procedure towards the relay UE. Alternatively, the remote UE may only respond to PC5 message if it receives a PC5 message from the relay UE (optionally indicating it is exempt), when it is known to the remote UE that the relay UE is in a restricted area (e.g. of the remote UE's serving PLMN).

Otherwise, if the remote UE determines that the relay UE is in a restricted area (e.g. of the remote UE's serving PLMN), and optionally if the remote UE determines that the relay UE is not exempt from service area restrictions, which may also mean that the remote UE is not exempt from communicating with such a relay UE that is known to be in a restricted service area (e.g. via means that are explained herein), then the remote UE should not perform any PC5 procedure towards the relay UE. Alternatively, the remote UE will only be allowed to perform a set of particular procedures e.g. engage in model B discovery to respond to any PC5 discovery message from the relay UE, or only respond to the relay UE if the relay UE initiates any PC5 procedure towards the remote UE.

Note that a “PC5 procedure” may refer to any of: a PC5 discovery procedure (e.g. Model A and/or Model B), any PC5 signalling procedure, any PC5 communication procedure, or any combination of these.

In one variant of the invention, if a relay UE is exempt from service area restrictions based on the above (or based on any other condition for an exempt) and is allowed to use ProSe services in a restricted service area:
The relay UE as part of identifiers for Layer-2 UE-to-Network Relay or Layer-3 UE-to-Network Relay may indicate in the discovery messages or responses (based on either Model A or Model B) the tracking area (e.g. TAI) it is located in, and/or, whether or not it is in a restricted area of its own serving PLMN.
   This indication may be used by remote UEs to determine whether or not they should initiate a (PC5) link establishment procedure (e.g. using the necessary PC5 procedures) or not. If the remote UEs determine that themselves and/or the relay UE are in a restricted service area of the remote UE's serving PLMN (e.g. based on TAI indication) and remote UEs are themselves not high priority access then they should not initiate a (PC5) link establishment procedure, otherwise they can. Optionally, if the remote UE are also exempt from a restriction (e.g. as explained earlier), then the remote UEs can initiate, or respond to, a PC5 procedure.
      For example, a remote UE may determine if it can use a particular UE-to-Network Relay UE based on any of the following criteria, optionally in some ordered manner:
The remote UE may determine the TAI of the serving cell in which the UE-to-Network Relay UE is currently in, for example where this information may be received by the remote UE, optionally from the UE-to-Network Relay UE, in any PC5 discovery and/or signaling message.
   The remote UE can/may then determine if the PLMN ID of the TAI that is received is the same as the PLMN ID that the UE was last registered with, or if the PLMN ID is an equivalent PLMN to the PLMN that the remote UE was last registered with. For example, this determination may be done by comparing the PLMN ID part of the TAI against the last registered PLMN ID or the PLMN ID(s) associated with the TAI(s) that was previously received by the remote UE (i.e. when the remote UE was previously in coverage, and hence was not considered to be remote) in the previous/last registration area information (or the previous/last list of 5GS tracking area identity)
   The remote UE may also compare the TAI of the UE-to-Network Relay UE against the TAI(s) of its last registration area. If the TAI of the UE-to-Network Relay UE matches any of the TAI(s) in the remote UE's last registration area, then the remote UE may further verify if the TAI (that is received from the UE-to-Network Relay UE) is considered to be an allowed TAI (and/or hence an allowed area) or a non-allowed TAI (and/or hence a non-allowed area). Note that the remote UE may consider the TAI that is received from the UE-to-Network Relay UE, in any PC5 discovery and/or signaling message, as the TAI that the remote UE is camping on. Hence, the remote UE may verify if it is in an allowed area or not based on a comparison between the TAI in the service area list information (which contains information about which TAI(s) is/are restricted or not, etc) with the TAI that the remote UE has received from the UE-to-Network Relay UE (as described above) and which the remote UE may consider to be the TAI that the remote UE is camping on. Note also that the last registration area (or the TAI in the last registration area) of the remote UE may be considered the current registration area of the remote UE e.g. if the UE is successfully registered with the network via the UE-to-Network Relay UE.
   If the remote UE considers the TAI to be allowed (as described above), then the remote UE may consider itself to be in an allowed area or it may consider the UE-to-Network Relay UE to be a UE that is in an allowed area.
   If the remote UE considers the TAI to be a non-allowed (as described above), then the remote UE may consider itself to be in a non-allowed area or it may consider the UE-to-Network Relay UE to be a UE that is in a non-allowed area.
   If the remote UE determines that a UE-to-Network Relay UE is associated with or is in an allowed area, then the remote UE may determine that it can communicate via the UE-to-Network Relay UE and may optionally initiate a PC5 communication with the UE-to-Network Relay UE (where a PC5 communication may mean the exchange of PC5 discovery messages, or PC5 signaling messages, or direct PC5 communication messages that carry user plane data). Although the remote UE is not in coverage, it can assume that it is in an allowed area with respect to the particular UE-to-Network Relay UE from which the TAI was received as explained above.
   If the remote UE determines that a UE-to-Network Relay UE is associated with or is in a non-allowed area, then the remote UE may determine that it cannot communicate via the UE-to-Network Relay UE and hence may not initiate any PC5 communication with the UE-to-Network Relay UE, or may only be allowed to perform a subset of PC5 operations, where PC5 operations is not restricted to communication of user plane but may be any combination of PC5 discovery messages, or PC5 signaling messages, or direct PC5 communication messages that carry user plane data
   If the remote UE determines that a UE-to-Network Relay UE cannot be used for communication with the network e.g. because the remote UE determines that the UE-to-Network Relay UE is in a non-allowed area (or that the remote UE would consider itself to be in a non-allowed area had the remote UE been in the same serving cell/TAI as the UE-to-Network Relay UE), then the remote UE can attempt to discover another UE-to-Network Relay UE and/or choose another UE-to-Network Relay UE.
   The remote UE may behave as described above in order to select or reselect a UE-to-Network Relay UE.
   If a remote UE was previously not registered, and hence may not have a valid registration area in order to determine its presence, or the presence of the UE-to-Network Relay UE, in an allowed area or a non-allowed area (e.g. as proposed/explained above), then the default behavior for the remote UE may be: to use a given UE-to-Network Relay UE for communication with the network, or to not use a UE-to-Network Relay UE for communication with the network, or the remote UE may be preconfigured with the default behavior such as any of the above.
   Optionally, the proposals above may be for a specific relay service code, where for example the proposals apply when one or more known (e.g. preconfigured) relay service codes are discovered or being broadcast, etc.
   When the remote UEs go out of coverage, the service area restrictions are not applicable to the remote UEs. As such, the remote UE's default behaviour may be that it can attempt to get service from a UE-to-Network Relay UE, where the latter may optionally determine if it can serve the remote UE or not (e.g. based on the UE-to-Network Relay UE determining if it is itself within an allowed area or a non-allowed area, or based on other criteria). Alternatively, when the remote UEs go out of coverage, the service area restrictions are with respect to stored information from the last PLMN serving the remote UEs as outlined in the examples above.
   Note that although the example listed above may be related to a (PC5) link establishment, the PC5 procedure that a UE (e.g. a relay UE or a remote UE) may be allowed to perform (e.g. due to a determination of being exempt from a restriction e.g. service area restriction) is not restricted to a (PC5) link establishment procedure only. The PC5 procedure may be any other procedure as have been explained earlier e.g. PC5 link modification, PC5 link release, PC5 discovery, PC5 signalling, etc.
A relay UE that is, based on some determination, providing relay service to potential remote UEs should only do so if the remote UEs are themselves exempt from service area restrictions or when service area restrictions are not applicable to the remote UEs (e.g. when the remote UEs themselves are not in restricted service areas corresponding to their PLMNs or when the remote UEs are out of coverage or in case remote UEs belong to a different a PLMN than the relay UE). This is due to the fact that if such high priority access remote UEs were directly served by the RAN, they would have been able to use all services even in restricted service areas.
A relay UE may, e.g. based on being present in a restricted area or based on the availability of any other type of restriction, solicit remote UEs to indicate whether or not they are exempt from the type of restriction. As such, the relay UE may, using any PC5 message (e.g. discovery message or other PC5 signalling messages) indicate any type of restriction that is in place and thereby by so doing the relay UE optionally requests a remote UE to indicate whether or not it is exempt from the indicated restriction.
Based on a change in the relay UE's configuration or based on any update or updated indication about a restriction (e.g. restriction no longer available, etc) that may be received by the relay UE (e.g. in response to Service Request message initiated from the relay UE to the network), optionally from any network entity (including an application function or 5G DDNMF) and optionally using any NAS messages e.g. via AMF and/or SMF (and/or NAS IE or container, etc), the relay UE may update the remote UE about the new status of any restriction using any of the means indicated herein. This may also be done when the relay UE e.g. enters a restriction area or leaves a restricted area, or determines a change in the status of any restriction (e.g. when the relay UE plans to transition to CM-connected mode in a non-allowed area of its own serving PLMN).
The relay UE, e.g. after determining that a restriction applies, optionally for a particular remote UE (or for any set of remote UEs), may initiate any 5GSM procedure (e.g. if the relay UE is exempt from the restriction) towards the network to modify any context in the relay UE which is related to the service provided for the remote UE (e.g. as already established based on the remote UE reports). As an example, the relay UE may modify a PDU session to release any packet filters (PFs), or any QoS related parameters, that is in use for the remote UE for which there is a restriction, or to refrain from activating user plane resources between the relay and the network for the remote UE for which there is a restriction or even when the relay UE detects that the restriction applies to itself. Similarly, the relay UE can take similar actions when the restriction is deemed to no longer be application to a remote UE or to a relay UE, or both.
The relay UE may report to a network entity (e.g. AMF using 5GMM NAS messages, or an SMF using 5GSM NAS messages) whether a remote UE (or any context that is being used for the relay UE or remote UE) is subject to a restriction or is not subject to a restriction. E.g. this may be done when the relay UE establishes or uses new packet filters or modifies any QoS parameters based due a to request from a remote UE which has been determined to be exempt from a restriction (where this determination may be based on any of the methods described herein).

In another variant of the invention, if a remote UE is exempt from service area restrictions based on the above and is allowed to use ProSe services in a restricted service area:
The remote UE as part of identifiers for Layer-2 UE-to-Network Relay or Layer-3 UE-to-Network Relay may indicate in the discovery messages or responses (based on either Model A or Model B) whether or not it is exempt from at least one restriction (e.g. a service area restriction) e.g. based on the remote UE being a high priority access UE or being part of a particular group of UEs with high priority access or where the relay service code may imply a service of high priority (e.g. MPS, MCS, etc.). This indication may be sent by the remote UE regardless of whether the remote UE has determined that it is exempt, or not exempt, from a restriction (e.g. service area restriction), where the determination may be achieved using any of the means explained earlier.
The relay service code may also either implicitly or explicitly identify authorized high priority users (or a remote UE, or a set of remote UEs, that is/are exempt from a restriction e.g. service area restriction) that the relay UE would offer service to, and may be used to select the related security policies or information e.g. necessary for authentication and authorization between the Remote UE and the ProSe UE-to-Network Relay. The remote UE may solicit a relay UE to indicate if there is any restriction in place and for which the remote UE may need to indicate whether or not it is exempt from any restriction. Alternatively, the remote UE may indicate whether or not it is exempt from any restriction.
Note that any of the above may be performed using any PC5 message, any discovery model, etc. And any of the above may be taken in any combination e.g. based on a UE configuration and/or a particular discovery code (that is in use).

Note that for all the proposals herein may also be applicable based on other forms of restrictions, e.g. RAT restriction, Forbidden Area, or CN type restriction, congestion control (e.g. S-NSSAI congestion control, DNN congestion control, or congestion control for a combination of S-NSSAI and DNN) etc. As such, any of these restrictions may be referred to as “a restriction”. Although the proposals herein may be provided or described using service area restriction (e.g. restricted service area) as an example, the proposals would still apply for any other form of restrictions such as those listed herein. Moreover, the proposals can be used, in any combination, for at least one type of restriction and optionally can be used simultaneously when more than one restriction applies.

URSP ANDSP of ProSe UEs when in a Restricted Service Area

UE Route Selection Policy (URSP) is used by the ProSe UE to determine how to route outgoing traffic. Traffic can be routed to an established or a new PDU Session or can be offloaded to non-3GPP access outside a PDU Session. In all these options, direct network communication, would be in operation. Alternatively, traffic can be routed via a Layer-2 UE-to-Network Relay, Layer-3 UE-to-Network Relay or Layer-3 UE-to-Network Relay with N3IWF. In all these case, indirect network communication, would be in operation.

A remote UE as a ProSe UE can be pre-configured with certain URSP rules indicating whether to choose options outlined for direct network operation or options outlined for indirect network operation. Alternatively a remote UE can be provisioned with such URSP rules from the PCF in the HPLMN.

In one variant of the invention, the PCF in (H)PLMN identifies the service area restrictions from the PCF in (V)PLMN and determines the desired traffic route accordingly:
For a remote UE in a restricted service area of (V)PLMN which is not exempt, a route via non-3GPP access outside a PDU session or Layer-3 UE-to-Network Relay with N3IWF can be configured within the URSP by the PCF. The location criteria as part of route validation criteria can be set to the TAIs in the restricted service area of (V)PLMN ensuring such URSP rule would be only valid when remote UE is in a restricted service area.
For a remote UE that is restricted from using any connectivity to an N3IWF (e.g. due to Core Network type restriction), a route via new/existing PDU session or via Layer-2 UE-to-Network Relay/Layer-3 UE-to-Network Relay without N3IWF can be configured within the URSP by the PCF.

In another variant of the invention, the PCF in (H)PLMN identifies the service area restriction change via (V)PLMN and updates the URSP accordingly:
The URSP for a remote UE in a restricted service area of (V)PLMN (which is not exempt), is updated where the location criteria as part of route validation criteria is updated based on new TAIs in the restricted service area of (V)PLMN.

Access Network Discovery & Selection Policy (ANDSP) is used by the remote UE for selecting non-3GPP accesses network.

In another variant of the invention, the PCF in (V)PLMN updates the forbidden area change to the PCF (H)PLMN and the PCF in (H)PLMN updates the ANDSP accordingly:
The PC5 path access node selection information is updated such that the (V)PLMN is removed from prioritized list of PLMNs for N3IWF selection/N3IWF identifier configuration.

In another variant of the invention, the PCF in (V)PLMN updates the ANDSP directly as above based on the forbidden area change.

Note that for all the proposals herein may also be applicable based on other forms of restrictions, e.g. RAT restriction, Forbidden Area, or CN type restriction, congestion control (e.g. S-NSSAI congestion control, DNN congestion control, or congestion control for a combination of S-NSSAI and DNN) etc. As such, any of these restrictions may be referred to as “a restriction”. Although the proposals herein may be provided or described using service area restriction (e.g. restricted service area) as an example, the proposals would still apply for any other form of restrictions such as those listed herein. Moreover, the proposals can be used, in any combination, for at least one type of restriction and optionally can be used simultaneously when more than one restriction applies.

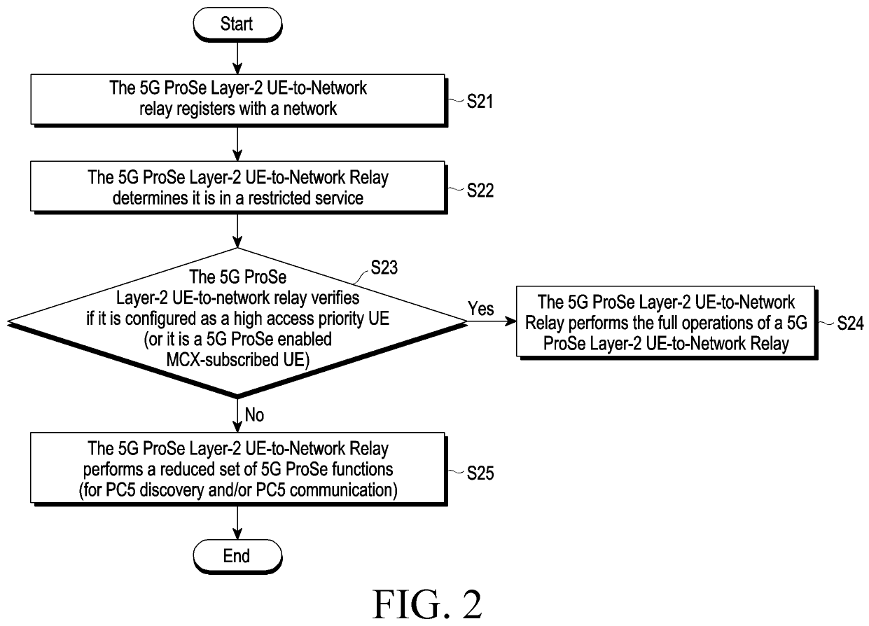

FIGS. 2 to 4 show flowcharts associated with embodiments of the present invention. Note that although these figures show a L2 relay UE, the same would apply for an L2 remote UE and should be interpreted accordingly.

FIG. 2 shows a flowchart relating to the case showing general behaviour between UE with high access priority vs UE without high access priority. The steps therein are described below.

S21: The 5G ProSe Layer-2 UE-to-Network Relay registers with a network.

S22: The 5G ProSe Layer-2 UE-to-Network Relay determines it is in a restricted service area.

S23: The 5G ProSe Layer-2 UE-to-Network Relay verifies if it is configured as a high access priority UE (or it is a 5G ProSe enabled MCX-subscribed UE).

S24: If the determination at S23 is YES, then the 5G ProSe Layer-2 UE-to-Network Relay performs the full operations of a 5G ProSe Layer-2 UE-to-Network Relay i.e. the UE does not follow the principles of a UE in limited service state e.g. the 5G ProSe enabled UE does not stop performing procedures related to a 5G ProSe Layer-2 UE-to-Network Relay and as such applies the normal/full operation that is related to a 5G ProSe Layer-2 UE-to-Network Relay.

S25: If the determination at S23 is NO, then the 5G ProSe Layer-2 UE-to-Network Relay performs a reduced set of 5G ProSe functions (for PC5 discovery and/or PC5 communication) e.g. the 5G ProSe enabled UE follows the principles of a UE in limited service state although the UE is in state 5GMM-REGISTERED.NON-ALLOWED-SERVICE. For example, the 5G ProSe enabled UE stops performing procedures related to a 5G ProSe Layer-2 UE-to-Network Relay.

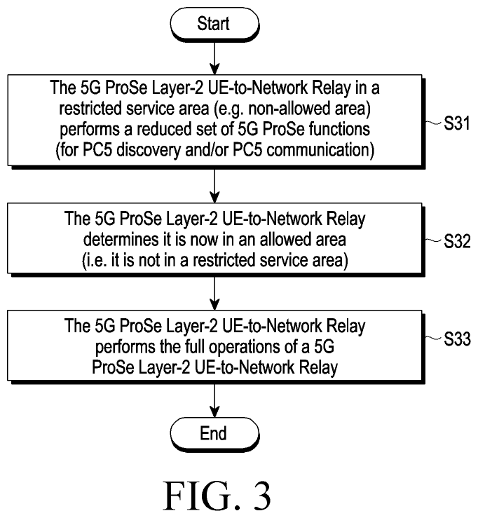

FIG. 3 shows a flowchart related to the case when the UE is in a non-allowed area and moves into an allowed area, showing the switch in behaviour accordingly. The steps therein are described below.

S31: The 5G ProSe Layer-2 UE-to-Network Relay in a restricted service area (e.g. non-allowed area) performs a reduced set of 5G ProSe functions (for PC5 discovery and/or PC5 communication). E.g. the 5G ProSe enabled UE follows the principles of a UE in limited service state although the UE is in state 5GMM-REGISTERED.NON-ALLOWED-SERVICE. E.g. the 5G ProSe enabled UE stops performing procedures related to a 5G ProSe Layer-2 UE-to-Network Relay.

S32: The 5G ProSe Layer-2 UE-to-Network Relay determines it is now in an allowed area (i.e. it is not in a restricted service area)

S33: The 5G ProSe Layer-2 UE-to-Network Relay performs the full operations of a 5G ProSe Layer-2 UE-to-Network Relay i.e. the UE does not follow the principles of a UE in limited service state. E.g. the 5G ProSe enabled UE does not stop performing procedures related to a 5G ProSe Layer-2 UE-to-Network Relay and as such applies the normal/full operation that is related to a 5G ProSe Layer-2 UE-to-Network Relay

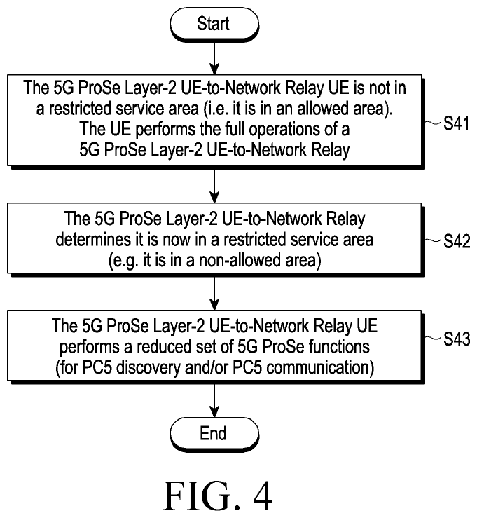

FIG. 4 shows a flowchart related to the case when the UE is an allowed area & moves to a non-allowed area, showing the switch in behaviour accordingly. The steps therein are described below.

S41: The 5G ProSe Layer-2 UE-to-Network Relay UE is not in a restricted service area (i.e. it is in an allowed area). The UE performs the full operations of a 5G ProSe Layer-2 UE-to-Network Relay i.e. the UE does not follow the principles of a UE in limited service state. E.g. the 5G ProSe enabled UE does not stop performing procedures related to a 5G ProSe Layer-2 UE-to-Network Relay and as such applies the normal/full operation that is related to a 5G ProSe Layer-2 UE-to-Network Relay

S42: The 5G ProSe Layer-2 UE-to-Network Relay determines it is now in a restricted service area (e.g. it is in a non-allowed area)

S43: The 5G ProSe Layer-2 UE-to-Network Relay UE performs a reduced set of 5G ProSe functions (for PC5 discovery and/or PC5 communication). E.g. the 5G ProSe enabled UE follows the principles of a UE in limited service state although the UE is in state 5GMM-REGISTERED.NON-ALLOWED-SERVICE. E.g. the 5G ProSe enabled UE stops performing procedures related to a 5G ProSe Layer-2 UE-to-Network Relay

All the proposals herein can be used in any order and in any combination.

It should be noted that the UE being in a restricted area (i.e. the UE is in a non-allowed area or the UE is not in an allowed area) means that the UE would be in state 5GMM-REGISTERED.NON-ALLOWED-SERVICE. If the UE is in an allowed area (or not in a non-allowed area) then the UE would be in state 5GMM-REGISTERED.NORMAL-SERVICE. As such any of the proposals herein which require the UE to take any action when the UE leaves a restricted area to a non-restricted area can also mean that the UE takes the proposed action upon changing states from 5GMM-REGISTERED.NON-ALLOWED-SERVICE to 5GMM-REGISTERED.NORMAL-SERVICE. Similarly, any action that is proposed to be taken when the UE is in a restricted area can mean that the UE should take the action upon changing state from 5GMM-REGISTERED.NORMAL-SERVICE to 5GMM-REGISTERED.NON-ALLOWED-SERVICE.

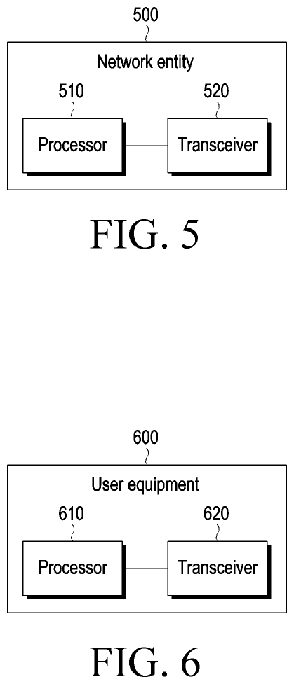

FIG. 5 shows various hardware components of the network entity (500) in the wireless communication system, according to various embodiments as disclosed in this application.

The network entity comprises various network function entities in core network (e.g. 5G CORE). The network entity (500) includes at least one of AMF (Access and Mobility Management Function), SMF(Session Management Function), PCF(policy control function), UPF(user plane function), UDM(Unified Data Management), NEF(Network Exposure Function), AUSF(Authentication Server Function), AAA(Authentication, Authorization, and Accounting) Server, AF(Application Function), and/or base station(eg. NG-RAN).

In an example embodiment, the network entity (500) includes at least one processor (510) and transceiver (520). The at least one processor (510) is coupled with the transceiver (520). The at least one processor (510) is configured to perform various processes. The transceiver (520) is configured for communicating internally between internal hardware components and with external devices via one or more networks.

Although the FIG. 5 shows various hardware components of the network entity (500) but it is to be understood that other example embodiments are not limited thereto. In other example embodiments, the network entity (500) may include less or more components. Further, the labels or names of the components are used only for illustrative purposes.

FIG. 6 shows various hardware components of the UE (600) in the wireless communication system, according to various embodiments as disclosed in this application. The UE (600) can be, for example but not limited to a cellular phone, a tablet, a smart phone, a laptop, a Personal Digital Assistant (PDA), a global positioning system, a multimedia device, a video device, an internet of things (IoT) device, a smart watch, a game console, a smart watch, a foldable display device, an Unmanned Aerial Vehicle (UAV), an airplane or the like. The UE (600) may also be referred to by those skilled in the art as a mobile station, a subscriber station, a mobile unit, a subscriber unit, a wireless unit, a remote unit, a mobile device, a wireless device, a wireless communications device, a mobile subscriber station, an access terminal, a mobile terminal, a wireless terminal, a remote terminal, a handset, a user agent, a mobile client, or the like.

In an example embodiment, the UE (600) includes at least one processor (610) and transceiver (620). The at least one processor (610) is coupled with the transceiver (620). The at least one processor (610) is configured to perform various processes. The transceiver (620) is configured for communicating internally between internal hardware components and with external devices via one or more networks.

Although the FIG. 6 shows various hardware components of the UE (600) but it is to be understood that other example embodiments are not limited thereto. In other example embodiments, the UE (600) may include less or more components. Further, the labels or names of the components are used only for illustrative purposes.

### REFERENCES

[1] 3GPP TR 23.752 V0.5.0
[2] 3GPP TS 23.501 V17.X.Y
[3] 3GPP TS 24.501 V17.2.0

### Definitions

Although presented in terms of ProSe and 5GS, the skilled person will readily appreciate that other network topologies and/or protocols which rely on group communication between UEs will benefit from embodiments of the invention.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a network entity in a wireless communication, the method comprising:
defining a proximity services (ProSe) behavior of at least one of a first user equipment (UE) or a second UE in respect of a restricted service area;
preconfiguring the at least one of the first UE or the second UE according to the defined ProSe behavior; and
transmitting, to the at least one of the first UE or the second UE, information of the defined ProSe behavior of the at least one of the first UE or the second UE,
wherein the ProSe behavior indicates whether at least one PC5 procedure related to a PC5 interface of the at least one of the first UE or the second UE is permitted.

2. The method of claim 1, wherein defining the ProSe behavior of the at least one of the first UE or the second UE in respect of the restricted service area comprises at least one of:
denying at least one the PC5 procedure in the restricted service area;
permitting the at least one PC5 procedure in the restricted service area;
conditionally permitting the at least one PC5 procedure in the restricted service area; or
permitting the at least one PC5 procedure applicable to the at least one of the first UE or the second UE as being in a limited service state even though the at least one of the first UE or the second UE is in a state 5GMM-REGISTERED.NON-ALLOWED-SERVICE.

3. The method of claim 1, wherein defining the ProSe behavior of the at least one of the first UE or the second UE in respect of the restricted service area comprises applying the ProSe behavior of the at least one of the UE in a limited service state even though the at least one of the first UE or the second UE is in a state 5GMM-REGISTERED.NON-ALLOWED-SERVICE.

4. The method of claim 1, wherein the tracking area identity (TAI) of a serving cell associated with the first UE is determined based on the PC5 procedure of the second UE.

5. (canceled)

6. (canceled)

7. The method of claim 1, wherein defining the ProSe behavior of the first UE in respect of the restricted service area comprises:
permitting the first UE to perform a service request procedure to transition to a connected mode for at least one of PC5 discovery or PC5 communication, in case that the first UE is positioned in the restricted service area; or
permitting the first UE to perform a registration procedure in order to transition to a connected mode for the at least one of PC5 discovery or PC5 communication, in case that the first UE is positioned in the restricted service area.

8. The method of claim 1, wherein defining the ProSe behavior of the first UE in respect of the restricted service area comprises:
permitting the first UE to perform at least one of PC5 discovery or PC5 communication, wherein the UE is in a 5GMM-CONNECTED mode or in a 5GMM-CONNECTED mode with RRC inactive indication, in case that the first UE is positioned in the restricted service area,
wherein permitting the first UE to perform the PC5 discovery comprises conditionally permitting the first UE to perform the PC5 discovery, wherein a condition requires that in case that the first UE detects a match, the first UE waits until entering or exiting the restricted service area before sending a match report.

9. The method of claim 1, wherein defining the ProSe behavior of the first UE in respect of the restricted service area comprises permitting the first UE to contact the-a network for a match report or to request a ProSe code for PC5 discovery or to perform PC5 communications, in case that the first UE is positioned in the restricted service area.

10. The method of claim 1, further comprising:
configuring at least one of the first UE or the second UE according to the defined ProSe behavior in a universal subscriber identity module (USIM) or provisioned in the UE.

11. The method of claim 1, wherein defining the ProSe behavior of the first UE in respect of the restricted service area comprises:
configuring that the first UE supports the second UE for ProSe services, in case that the first UE is positioned in the restricted service area.

12. The method of claim 1,
wherein the at least one of the first UE or the second UE is configured to release the ProSe behavior in the restricted service area, in case that the at least one of the first UE or the second UE is configured for multimedia priority service (MPS), mission critical services (MCS) or another high priority access service and
wherein the another high priority access service is explicitly or implicitly identified by relay service codes as preconfigured or provisioned to the at least one of the first UE or the second UE, or based on other indications in discovery messages or responses.

13. (canceled)

14. A network entity in a wireless communication system, the network entity comprising,
a transceiver; and
at least one processor coupled with the transceiver and configured to:
define a proximity services (ProSe) behavior of at least one of a first user equipment (UE) or a second UE in respect of a restricted service area,
preconfigure the at least one of the first UE or the second UE according to the defined ProSe behavior, and
transmit, to the at least one of the first UE or the second UE, information of the defined ProSe behavior of the at least one of the first UE or the second UE,
wherein the ProSe behavior indicates whether at least one PC5 procedure related to a PC5 interface of the at least one of the first UE or the second UE is permitted.

15. (canceled)

16. The network entity of claim 14, wherein the at least one processor is further configured to:
deny at least one the PC5 procedure in the restricted service area,
permit the at least one PC5 procedure in the restricted service area,
conditionally permit the at least one PC5 procedure in the restricted service area, or
permit the at least one PC5 procedure applicable to the at least one of the first UE or the second UE as being in a limited service state even though the at least one of the first UE or the second UE is in a state 5GMM-REGISTERED.NON-ALLOWED-SERVICE.

17. The network entity of claim 14, wherein the at least one processor is further configured to:
apply the ProSe behavior of the at least one of the UE in a limited service state even though the at least one of the first UE or the second UE is in a state 5GMM-REGISTERED.NON-ALLOWED-SERVICE.

18. The network entity of claim 14, wherein tracking area identity (TAI) of a serving cell associated with the first UE is determined based on the PC5 procedure of the second UE.

19. The network entity of claim 14, wherein the at least one processor is further configured to:
permit the first UE to perform a service request procedure to transition to a connected mode for at least one of PC5 discovery or PC5 communication, in case that the first UE is positioned in the restricted service area, or
permit the first UE to perform a registration procedure in order to transition to a connected mode for the at least one of PC5 discovery or PC5 communication, in case that the first UE is positioned in the restricted service area.

20. The network entity of claim 14, wherein the at least one processor is further configured to:
permit the first UE to perform at least one of PC5 discovery or PC5 communication, wherein the UE is in a 5GMM-CONNECTED mode or in a 5GMM-CONNECTED mode with RRC inactive indication, in case that the first UE is positioned in the restricted service area, or
conditionally permit the first UE to perform the PC5 discovery, wherein a condition requires that in case that the first UE detects a match, the first UE waits until entering or exiting the restricted service area before sending a match report.

21. The network entity of claim 14, wherein the at least one processor is further configured to:
permit the first UE to contact a network for a match report or to request a ProSe code for PC5 discovery or to perform PC5 communications, in case that the first UE is positioned in the restricted service area.

22. The network entity of claim 14, wherein the at least one processor is further configured to:
configure at least one of the first UE or the second UE according to the defined ProSe behavior in a universal subscriber identity module (USIM) or provisioned in the UE.

23. The network entity of claim 14, wherein the at least one processor is further configured to:
configure that the first UE supports the second UE for ProSe services, in case that the first UE is positioned in the restricted service area.

24. The network entity of claim 14,
wherein the at least one of the first UE or the second UE is configured to release the ProSe behavior in the restricted service area, in case that the at least one of the first UE or the second UE is configured for multimedia priority service (MPS), mission critical services (MCS) or another high priority access service, and
wherein the another high priority access service is explicitly or implicitly identified by relay service codes as preconfigured or provisioned to the at least one of the first UE or the second UE, or based on other indications in discovery messages or responses.
